(19) United States
(12) Patent Application Publication
(10) Pub. No.: US 2007/0081703 A1
(43) Pub. Date: Apr. 12, 2007

(54) Methods, devices and systems for multi-modality integrated imaging

(75) Inventor: Richard C. Johnson, Poquott, NY (US)

Correspondence Address: YOUNG LAW FIRM, P.C.;ALAN W. YOUNG, 4370 ALPINE ROAD, SUITE 106, PORTOLA VALLEY, CA, 94028, US

(73) Assignee: Industrial Widget Works Company, Poquott, NY (US)

(21) Appl. No.: 11/251,614

(22) Filed: Oct. 12, 2005

(51) Int. Cl. G06K 9/00

(52) U.S. Cl. 382/128

(57) ABSTRACT

Multi Media Integrated Imaging (MMII) includes methods, devices and systems that are effective in overcoming the shortcomings of conventional medical imaging techniques. Instead of generating a series of unrelated images taken at different times and obtained by several technologies, embodiments of the present invention generate a deeply detailed, coherent image taken simultaneously with several imaging modalities. In this manner, each three-dimensional coordinate point in the image is enriched by the different data provided by each of the plurality of imaging technologies employed. The data for each three-dimensional coordinate point is taken in each of the imaging modalities at a same point in time such that that the simultaneous capture of the multi-modality image data provides a crisp snapshot of the patient's internal structures.

This application claims the benefit of previously filed provisional application Ser. No. 60/617,800, filed Oct. 12, 2004, which application is hereby incorporated herein by reference in its entirety and from which application priority is hereby claimed under 35 U.S.C. §1.19(e).

### BACKGROUND OF THE INVENTION

1. Field of the Invention

Embodiments of the present inventions relate to medical imaging technology.

2. Description of the Related Art

Despite the use of various technologies to image the internal structures of the human body prior to surgery, surgeons often discover new and unanticipated information during surgery. Surgeons go to great lengths to obtain accurate images of their patient's anatomical details prior to surgery in an effort to minimize such surprises. The state of the art in medical imaging technology, however, suffers from a number of limitations. For example, although several different types of imaging (Magnetic Resonance Imaging (MRI), Computerized Axial Tomography (CAT), Positron Emission Tomography (PET), and Ultrasound scanning (US)) may be considered complementary, the images derived from these technologies have thus far not been combinable for coincident viewing. Indeed, the images obtained from such imaging modalities cannot readily be combined (e.g., combined and viewed in a superimposed manner). Some of the reasons for this are that the patient's orientation may have shifted between imaging sessions, the bones have moved relative to one another, and no two images of the same person may directly cross reference exactly the same features of that person's anatomy. This problem cannot be solved in current practice or state of the art, since each of the separate images is necessarily taken at different times with different imaging technologies. When such images are superimposed, the resulting image is unsatisfactory, as the combined image's resolution is degraded. This is because the patient's bones and soft tissues move relative to each other within imaging sessions and between imaging sessions. Moreover, the patient cannot be positioned in exactly the same manner across all imaging sessions. For example, no two MRI images are ever the same, even for the same patient, and an overlay invariably must lose resolution.

This set of problems is magnified when one considers the assembly of a Virtual Patient (VP) as the result of 3D images taken by different technologies and providing a rich set of data at each x, y, and z coordinate points. The fourth dimension, time (t), is also significant, given that patients inevitably move their bodies through time, even if restrained to minimize movement.

Physicians and surgeons have attempted to overlay images from alternative imaging systems of the same patient anatomical features. They also examine each of the separately imaged views of the same patient, attempting to identify the same phenomena in the serial views. Finally, many surgeons resort to detailed viewing and diagnosis only when they have surgically accessed the patient's physical features in question on the operating table. Often, the physician must then react quickly to problems as they present themselves on the operating table. With advance knowledge, surgical strategies and tactics of the surgeon might be quite different and the outcome for the patient may be greatly improved.

Testing of an MRI device depends on the use of artificial dummy heads referred to as “phantoms.” These provide a constant orientation and features which can be used to test the image processing functions of the overall MRI machine. The state of the testing art, however, is less satisfactory for real images of persons. The dummy heads can provide a basis for an unchanging image; comparison of images removed in time cannot be superimposed or compared without numerous differences blurring the image, in effect lowering the resolution of the combined image. This problem is common to all imaging of real persons, regardless of the imaging methodology or technology.

From the foregoing, it may be appreciated that there is a need for imaging methods, devices and systems that are effective to combine a plurality of imaging methodologies in a useful manner that does not degrade the resolution of the combined image as compared with the resolutions of each of the constituent imaging methodologies.

### BRIEF DESCRIPTION OF THE DRAWINGS

FIG. 1 shows aspects of a system for integrated multi-modality imaging system according to an embodiment of the present invention.

FIG. 2 shows further aspects of the present methods and systems for multi-modality imaging, according to an embodiment of the present invent

FIG. 3 is a flowchart illustrating aspects of a method for imaging a patient, according to an embodiment of the present invention.

FIG. 4 is a representation of an exemplary user interface of the present multi-modality imaging system, according to an embodiment of the present invention.

### SUMMARY OF THE INVENTION

According to an embodiment thereof, the present invention is a method of imaging a patient. The method may include steps of obtaining a first image of the patient from a first imaging modality along a first predetermined plane at a first predetermined time; obtaining a second image of the patient from a second imaging modality that is different from the first imaging modality, the second image being obtained along the first predetermined plane at the first predetermined time; associating the first predetermined time with the first and second obtained images and storing the first and second obtained images together with the first predetermined time in a memory; shifting either the patient or the first and second imaging modalities such that the first and second imaging modalities are effective to obtain a third and fourth images along a second predetermined plane at a second predetermined time that is later in time than the first predetermined time, obtaining a third image of the patient from the first imaging modality along the second predetermined plane at the second predetermined time; obtaining a fourth image of the patient from the second imaging modality, the fourth image being obtained along the second predetermined plane at the second predetermined time; associating the second predetermined time with the third and fourth obtained images, and storing the third and fourth obtained images together with the second predetermined time in the memory.

According to further embodiments, the first and second imaging modalities may be selected from a group including, for example, magnetic resonance imaging (MRI), computerized axial tomography (CAT), positron emission tomography (PET), and ultrasound scanning (US). The first and second images may each include respective positional image data points for each of an x-axis, a y-axis and a z-axis relative to an origin point. Each of the x, y and z positional image data points of the first and second images may be associated with the first predetermined time. Similarly, the second and third images may each include respective positional image data points for each of the x-axis, the y-axis and the z-axis relative to the origin point. Each of the x, y and z positional image data points of the third and fourth images may be associated with the second predetermined time. The first to fourth image obtaining steps may be carried out with the first and second imaging modalities including respective radio frequency identification devices (RFIDs) configured to store the first to fourth obtained images. The method may further include a step of polling the RFIDs to retrieve therefrom the first to fourth images to store them in the memory. The method may also include successively shifting either the patient or the first and second imaging modalities and successively repeating the obtaining, associating and storing steps so as to image at least a selected portion of the patient such that positional image data of each successive image of the patient from both of the first and second imaging modalities is associated with a same predetermine time. A step may be carried out to build and display a composite image of the patient using at least the obtained first, second third and fourth images. A step may be carried out of emphasizing or de-emphasizing contributions from any one of the first and second imaging modalities to the displayed composite image by selectively enhancing or subduing image data from the first, second third or fourth images. The obtaining steps may be carried out such that the second predetermined plane is adjacent and substantially parallel to the first predetermined plane.

According to another embodiment thereof, the present invention is a method of imaging a patient. The method may include steps of providing an imaging apparatus that includes a plurality of imaging modalities, each of the plurality of imaging modalities being configured to image the patient along a same predetermined plane; using the provided plurality of imaging modalities, simultaneously obtaining a corresponding plurality of images of the patient along the predetermined plane; storing, in a memory coupled to the imaging apparatus, the plurality of images of the patient together with an indication of a time at which the plurality of images were simultaneously obtained, and shifting either the patient relative to the imaging apparatus or shifting the imaging apparatus relative to the patient and repeating the simultaneous obtaining and storing steps.

The plurality of imaging modalities may be selected, for example, from a group including magnetic resonance imaging (MRI), computerized axial tomography (CAT), positron emission tomography (PET), and ultrasound scanning (US). Each of the plurality of images may include respective positional image data points for each of an x-axis, a y-axis and a z-axis relative to an origin point and each of the x, y and z positional image data points of the plurality of images taken simultaneously may be associated with the same predetermined time. The obtaining steps may be carried out with the plurality of imaging modalities including respective radio frequency identification devices (RFIDs) configured to store the first to fourth obtained images. The method may further include a step of polling the RFIDs to retrieve therefrom the plurality of images to store them in the memory (such as a database, for example). A step may be carried out of building and displaying a composite image of the patient using at least the obtained plurality of images. The method may also include a step of emphasizing or de-emphasizing contributions from any one of the plurality of imaging modalities to the displayed composite image by selectively enhancing or subduing image data from the plurality of images.

### DESCRIPTION OF THE PREFERRED EMBODIMENTS

Embodiments of the present invention achieve a simultaneous, exact, and precise coincidence of multiple views of the features of an individual's anatomy from two or more of MRI, CAT, PET and US. Embodiments of the present invention need not utilize each of these imaging technologies. For example, embodiments of the present invention may employ a combination of any two or three of these technologies. One embodiment utilizes all four such imaging technologies to great advantage, while the same principles disclosed here may be utilized in the combination of any number of different imaging technologies. Embodiments of the present invention, herein called Multi Media Integrated Imaging (MMII), include systems and methods that are effective in overcoming the above-detailed shortcomings of conventional medical imaging techniques. Instead of generating a series of unrelated images taken at different times and obtained by several technologies, embodiments of the present invention generate a deeply detailed, coherent image taken simultaneously with several imaging modalities. In this manner, each three-dimensional coordinate point in the image is enriched by the different data provided by each of the plurality of imaging technologies employed. Moreover, the data for each three-dimensional coordinate point is taken in each of the imaging modalities at a same point in time such that that the simultaneous capture of the multi-modality image data provides a crisp snapshot of the patient's internal structures with a number of imaging modalities.

Herein, the three spatial coordinates x, y and z and the single time coordinate t are considered to form a four dimensional coordinate structure. According to a first aspect of the embodiments of the present invention, each of the three spatial coordinates, x, y, x, and the single temporal coordinate t is associated with all of the relevant and appropriate data for that coordinate point generated by of the several modalities used for imaging. That is, according to embodiments of the present invention, the data points for each of the imaging modalities may be captured and stored such that they are associated with a specific coordinate in the four dimensional structure. Deviating from this format will logically and necessarily degrade the resolution of the combined image.

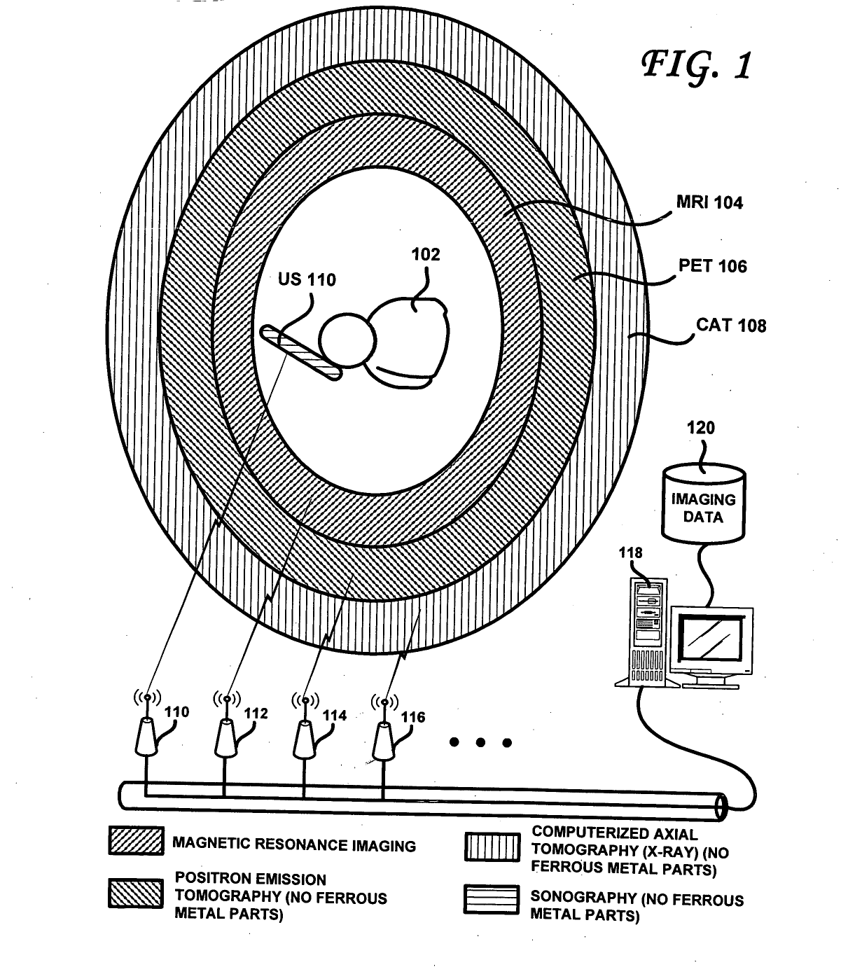

FIG. 1 shows aspects of a system for integrated multi-modality imaging system according to an embodiment of the present invention. According to an embodiment of the present invention, four imaging technologies may be employed simultaneously. These four imaging technologies may be MRI, CAT, PET and US. As shown in FIG. 1, the patient (who forms no part of the present inventions) is shown at reference numeral 102. The MRI, CAT, PET and US imaging devices 104, 106, 108 and 110, according to embodiments of the present inventions, are arranged in concentric circular fashion within a same imaging plane. In this manner, each of the imaging devices images the same internal structures at the same time.

The ultrasound device (e.g., ultrasound wand) 110, according to an embodiment of the present invention, may be mounted in any manner that is effective in aligning the imaging plane thereof with the imaging plane of the MRI, PET and CAT devices. For example, the ultrasound device may be mounted on a spring-loaded arm to press a rotating sonic sender/receiver wand against the person. An acoustically transmissive gel may be placed on the patient and/or dispensed by the device (e.g., by a roller mechanism). Then, instead of a human hand holding the ultrasound wand, an articulated spring-loaded arm may be deployed such that the coordinates, timing, and sweep of the ultrasound signal will be linked with the other signals. Care must be taken not to include any metallic parts in the ultrasound wand, because of the high magnetic fields generated around the patient.

Image data from each of these imaging devices 104, 106, 108 and 110 may be obtained in the same imaging plane, as the appropriate physical beams are configured to cut the same cross-section of the patient 102. According to embodiments of the present invention, an integrated assembly of the imaging devices 104, 106, 108 and 110 may be configured to move relative to a stationary patient 102. Alternatively, the patient 102 may be lying on a surface that may advantageously be configured to move back or forth or tilt and yaw at almost any angle relative to the imaging plane to obtain the desired images. Alternatively still, both patient 102 and the integrated assembly of imaging devices 104, 106, 108 and 110 may be configured to move along one or more of the x, y or z spatial directions. It is to be noted that the patient cannot have any ferrous objects within or on his or her person, as the powerful magnetic field generated within the integrated system of FIG. 1 (from the MRI) will both physically attract such metal and also generate unwanted electrical current in it or any conducting wire.

The imaging data, according to an embodiment of the present invention, may include data from successive imaging planes, and each of the imaging planes is associated with a time t. Therefore, each time t may be associated with the data generated by each of the employed imaging devices 104, 106, 108 and/or 110. By generating imaging data at successive times (t), a rich imaging data set is generated that is limited only by the desired resolution or other characteristics of the resulting images.

This imaging data may advantageously be stored in a computer memory for later analysis, digital manipulation and visualization. Each of the imaging devices 104, 106, 108 and/or 110 (or any combination thereof) may, as shown in FIG. 1, be equipped with Radio Frequency Identification Devices (RFID) such as described in co-pending and commonly assigned U.S. application Ser. No. 60/608,279, which is incorporated herein in its entirety. The imaging data generated by each of the devices 104, 106, 108 and/or 110 may then be stored in their respective RFIDs, and the RFID wireless access points shown in FIG. 1 at reference numerals 110, 112, 114 and 116 may then repeatedly and simultaneously poll the RFIDs, obtain the time-synchronized imaging data and transmit same to a computer 118 for storage, time-stamping, analysis, digital manipulation and visualization.

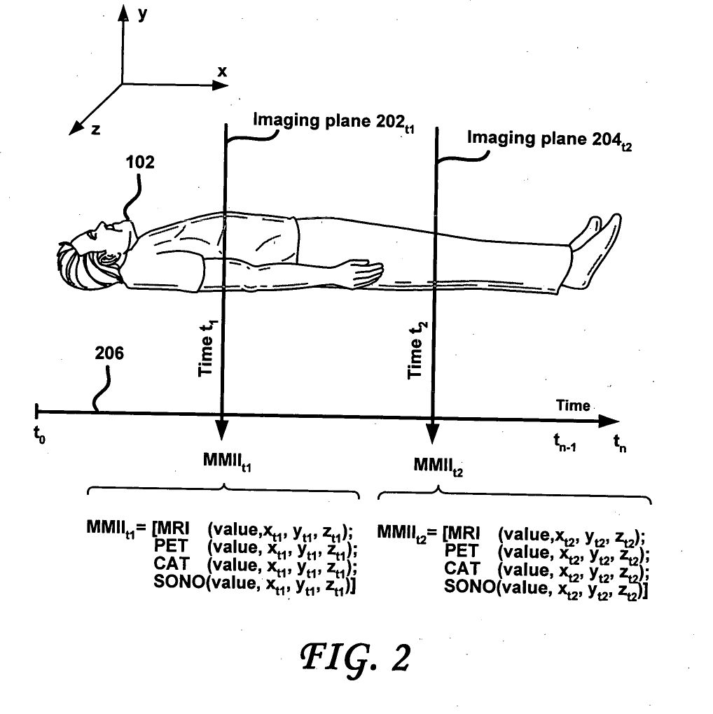

Further aspects of the present inventions and one possible format for the imaging data may be appreciated with reference to FIG. 2. Reference numeral 206 shows the time axis. Two imaging planes are shown in FIG. 2. Each of the imaging planes 202 and 204 cut a across a different cross-section of the patient 102 at different times. At time t₁, each of the imaging beams of the imaging devices 104, 106, 108 and/or 110 is aligned with the imaging plane 202 and generates imaging data that is associated with the time t₁, which is identified in FIG. 2 as MMIIt₁. The imaging data MMIIt₁ corresponding to time t₁ may be functionally organized as follows: MRI (value,xt₁, yt₁, ztₗ, t); PET(value, xt₁, yt₁, zt₁); CAT(value, xt₁, yt₁, zt₁); SONO(value, xt₁, yt₁, zt₁). In other words, each of the different imaging modalities generates a data point in each of the three spatial coordinates at the same time t₁. Moreover, all of the imaging data from each of the constituent imaging devices of the present assembly (see FIG. 1) within a same imaging plane is associated with a point in time. Another imaging plane 204 is shown in FIG. 2, and the data generated from scanning the patient across this imaging plane is associated with a time t₂, which may be later in time than time t₁.

Scanning, in this manner, may be carried out across a plurality of such imaging planes, as finely spaced in time as desired. By summing the resulting imaging data across coordinates, provides the basis for a three-dimensional representation of a person at time t. Moving the patient across stationary imaging devices 104, 106, 108 and/or 110 at a known rate or moving the imaging devices over the patient 102 at a known rate may be seen as shifting the x, y and z coordinates and as changing time t. Note that moving the patient must logically result in a change in t and, if the patient moves relative to the current plane of focus for the imaging equipment, the coordinates imaged will change as well. A living patient creates the assumption of at least some movement between imaging “snapshots” separated in time.

The resolution of the resultant multi-modality composite image remains consistently high, since the relation between the patient and the values of x, y, and z is coincident for each of the imaging modalities at any time t. All of the data from each of the imaging devices 104, 106, 108 and/or 110 may be stored (in a database 120, for example) in association with the x, y, z, t coordinates. Thus, at each x, y, and z there is a high resolution convergence of data.

According to embodiments thereof, the present inventions define simultaneous imaging (with 2 or more separate imaging devices 104, 106, 108 and/or 110) of a patient. This imaging takes place with all of the imaging technologies acting in the same plane (system of x, y, z coordinates relative to an origin 0, 0, 0 such that all values of x, y, and z correspond to a same value of time t). This means that each set of data captured at time t has a common set of reference points and that data portions may be associated with known coordinates common to each of the data-originating modalities. New planes (new sets of x, y, z coordinates and data specific to these coordinates) may be imaged at t+1 as the MMII scanner moves relative to the patient. The slices (one at each small time unit) may then be aggregated to build up a 3D image of the patient using the data generated from the employed imaging devices 104, 106, 108 and/or 110.

The image data sources 104, 106, 108 and/or 110 should preferably report their data within the same time interval and within the same spatial coordinate system. The time (t) specification is necessary to insure that movement of the patient will not blur the association between the image data and the spatial coordinates. However, a succession of x, y, z coordinated data will allow a series of “snapshots” to build a moving picture. Moving the patient deliberately through the plane of imaging of the imaging system will allow a relatively static 3-D image of the patient to be developed at high resolution. Within a relatively small interval (T-t), all data which in fact pertain to given x, y, z coordinates will be, in fact, associated with those coordinates. This is the basis, then, for a high resolution image. Any assignment of data to incorrect coordinates will degrade the image resolution, similar to the blurring of parts of a photograph by rapid movement. Embodiments of the present invention, therefore, use multiple imaging modalities at the same point in time before movement of the patient can degrade the resolution by assigning image data to the inappropriate coordinate set. The involvement of the time factor t as the fourth dimension of the present four dimensional system (x, y, z, t) is critical to the success of any multiple media imaging procedure according to the present inventions. Software manipulations may improve the allocation of time uncorrelated data to coordinates, but the improvement is only incremental and the resulting resolution can never reach the level of direct determination by 4 dimensional coincidence, as called for by embodiments of the present invention.

Note that movement of a patient, like that of a photographic subject, is less of a problem for rapid imaging than for relatively slower imaging devices. Thus the simultaneous application in time of the separate imaging modalities is critical to obtaining maximum image resolution. To do so, all imaging devices 104, 106, 108 and/or 110 must image the same patient features at the same time (or as close in time as practicable); that is, the imaging technologies must be mounted in the same known spatial framework so that their image data may be associated with the same coordinates.

The resulting multi-modality imaging data may then be stored in a database 120 and manipulated at will. The stored imaging data may then be assembled into a visual representation of the patient 102 in each of the imaging modalities with the appropriate software routines for each of the several imaging modalities. Such software may determine how the resulting image associated with the coordinates may be visually represented. For example, the US image may be associated with the organs and tissues that reflect the ultrasound waves sent into the body from known coordinates. The respective data from the plurality of imaging planes may be combined and inter-imaging plane data points may be interpolated, as is known in the imaging arts. The resulting composite image need not be visualized with all of the data associated with each time t. That is, the resulting composite image need not include all of the data available from each of the imaging devices 104, 106, 108 and/or 110. For example, the U.S. data may be digitally subtracted from the composite image, as may the data from any of the employed imaging devices 104, 106, 108 and/or 110.

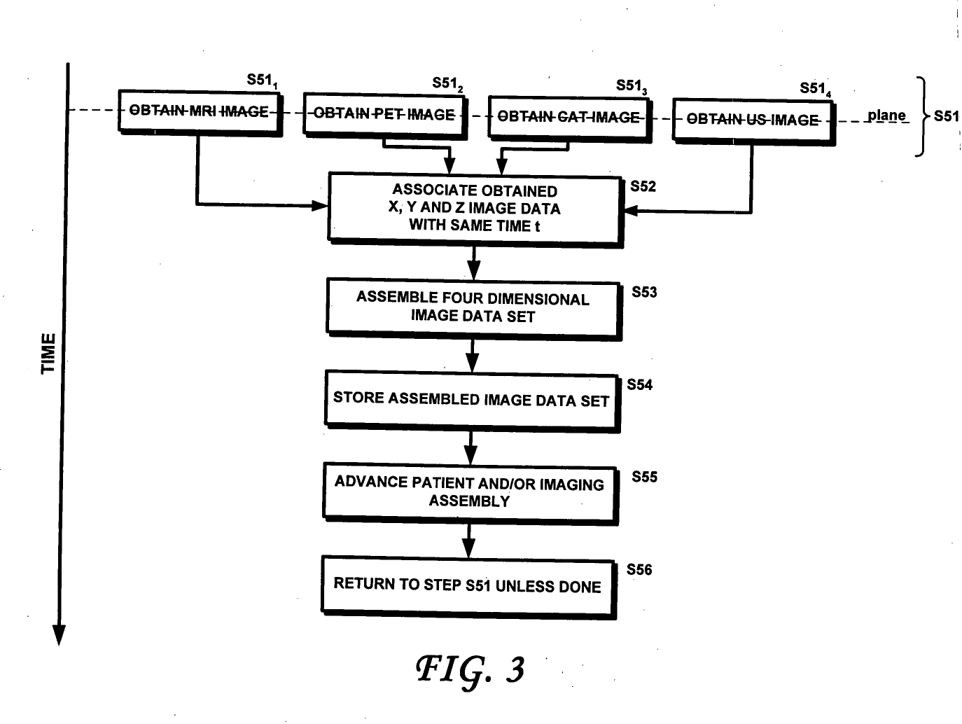

FIG. 3 is a flowchart illustrating aspects of a method for imaging a patient, according to an embodiment of the present invention. As shown, step S51 calls for simultaneously and in a same plane, obtaining at least two of an MRI image as shown at S51 ₁, a PET image as shown at S51₂, a CAT image as shown at S51₃ and/or an ultrasound image as shown at S51₄. Each of these steps is shown adjacent to one another, so as to indicate the coincidence in time (or as close in time as practicable) at which each imaging device 104, 106, 108 and/or 110 is to obtain its data. As called for by S52, the obtained x, y, and z data obtained from each of the imaging devices employed may then be associated with the same time t, and the resulting image data set assembled as shown at S53 and stored in a memory (such as database 120, for example), as called for by step S53. Then, the imaging plane may be shifted with respect to the patient by either advancing the patient through the imaging system or advancing the imaging system relative to a stationary patient, as suggested at S55. Thereafter, as shown at S56, a new image data set may then be obtained at the new imaging plane by returning to step S51.

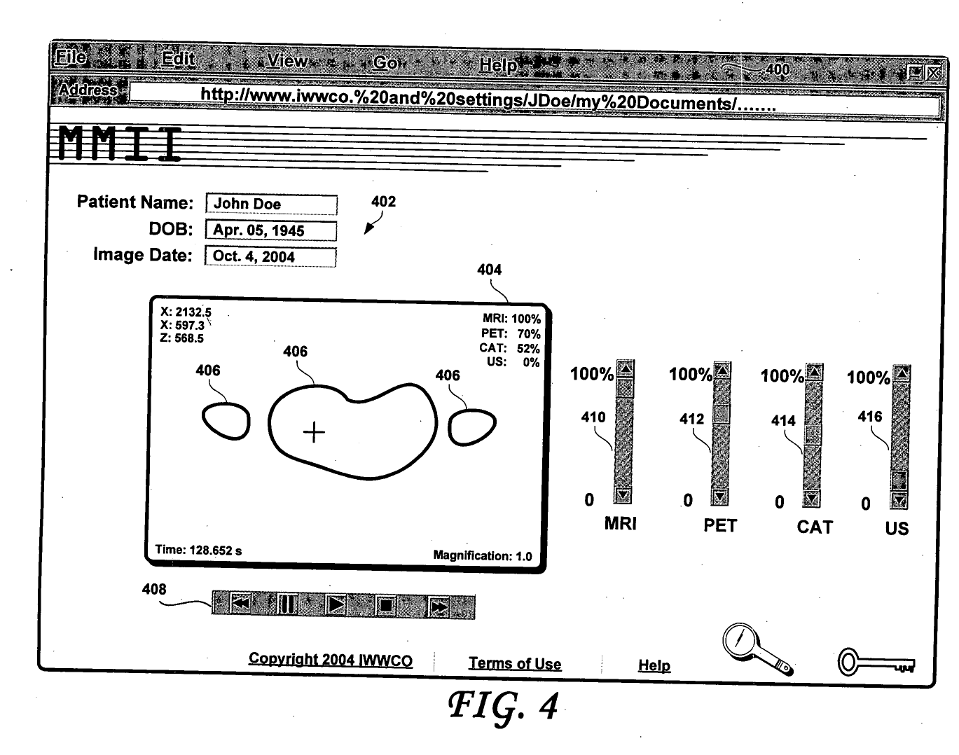

FIG. 4 is a representation of an exemplary user interface of the present multi-modality imaging system, according to an embodiment of the present interface may utilize a standard web browser as shown at 400 or may be embodied as a standalone application. As shown in FIG. 4, the user interface 400 may include a patient information section 402 that displays the patient's name, date of birth, and the date at which the images were taken. Other information may be displayed, as appropriate. The multi-modality display area is shown at 404, and the patient image at 406. The image may be an integrated composite of one or more of the images generated by the imaging devices 104, 106, 108 and/or 110. An image control section 408 controls how the image 406 is played. Using the image control section 408, the user may play the scans as a movie, pause the playback, stop the playback fast forward and rewind the playback, using a set of familiar and immediately intuitive controls. Individual sliders 410, 412, 414 and 416 may be provided. These sliders enable the user (e.g., a technician or physician) to control which imaging modality is present in the image 406, and to what degree (e.g., percentage) the imaging modality is represented in the resulting composite integrated multi-modality image. This may be done, for example, by varying the degree of transparency (0%=fully transparent−100%=fully opaque) of the pixels representative associated with each of the imaging devices imaging devices 104, 106, 108 and/or 110. In the exemplary case shown in FIG. 4, the pixels of the MRI image are fully opaque, the pixels of the PET image are 70% opaque, the pixels of the CAT image are 52% opaque, whereas the pixels of the ultrasound image have been rendered fully transparent (i.e., 100% transparent). The ability to control the opacity of the pixels associated with the images generated by each of the devices 104, 106, 108 and/or 110 enables the physician to fully control the composite image 406 across the various imaging modalities. Other digital manipulations of the multi modality imaging data will occur to those of skill in this art.

The data obtained according to one or more of the embodiments of the present invention may be utilized to construct a Virtual Patient (VP), at least for that portion of the patient 102 that has been scanned. Repeated scanning of a patient over extended periods of time may reveal the rate at which injuries heal or diseases progress. Accumulated data sets may also lead to the construction of VPs not related to any specific real person; portions of these full VPs may be substituted with relevant sections of an actual patient to make up a synthetic VP for the purpose of preparing an operation or performing diagnostic or hypothetical tests or treatments.

The availability of a VP produced as indicated above is the first requisite for Virtual Surgery (VS) and for Surgical Simulation (SS). VS requires that surgical tools, such as scalpel, forceps, rib separators, Stryker saws and other implements be equipped with positional indicators, such as WIFI RFID tags in several standard locations around each instrument so that its position relative to the VP may be spatially fixed. Each such instrument may be characterized in its effect on the different human tissues, as the amount of resistance to cutting or sawing correlated with specific VP measures of tissue characteristics at the coordinates traversed by the SS instrument would be known, to enable the overall changes to the VP exhibited in the VR viewers used by the surgeon in the simulation environment to be fully characterized and quantized. Optimally, the resistance attributed to the virtual scalpel will be fed back to the surgeon to guide the VS execution.

Next, to enable VS and SS, there must be provision for the force and attack position of the instrument or device wielded by the surgeon. The surgeon may then view the virtual image of the patient in a Virtual Reality (VR) simulator. This situation may be thought of as analogous to providing the performance, physical characteristics and controls of an aircraft to a flight simulator device. Using such simulators, pilots can be trained and practice dangerous maneuvers with no real risk. Surgeons may utilize similar technologies to equal advantage, assuming adequate provision of VP data and adequate feedback provision.

Student doctors and nurses often practice injections first on oranges, then on plastic dummies, and finally on each other. Far better would be the practicing of injections, setting lines for intravenous drip, and drawing blood in a simulator using data from a VP according to an embodiment of the present invention. Other applications of the multi-modality image data obtained from embodiments of the present invention may occur to those of skill in this art, and all such applications are deemed to fall within the purview of the present application.

For example, employing a VS and carrying out SS using imaging data obtained from the present inventions may enable and facilitate the training of new surgeons, training accomplished surgeons in new techniques, the cross-training of general surgeons in several specialties, and the specific preparation for dangerous, difficult, or micro-level surgeries, among other applications.

Advantageously, embodiments of the present invention enable high resolution, multi modality integrated images of patients that have the potential to advance both diagnosis and surgery. Furthermore, embodiments of the present invention enable the construction of a Virtual Patient, and Surgical Simulation and other medical simulations for training and practice.

A system as shown in FIG. 1 may be more costly than current standalone imaging systems. However, where warranted, embodiments of the present invention will save lives and money. Indeed, it is believed that much care is currently delivered with an inadequate understanding of the real patient beneath the knife. Embodiments of the present invention will provide the additional imaging and understanding of internal patient physiological features that will enable more precise and potentially less traumatic surgeries to take place.

MRI imaging is now widespread, and many occasions require surgeons to request as many pictures from as many different technologies as possible in an effort to get the best possible insights into a patient's specific anatomy prior to surgery. None of this is cheap. The combined image obtained using embodiments of the present invention in a single session may ultimately prove to be less expensive and less burdensome on the patient than carrying out a number of different imaging sessions on different occasions.

capability coupled with Surgical Simulation (SS) enables carrying out a Virtual Operation (VO), something not even remotely possible with current technology. However, with the imaging data specified across four dimensions (three spatial dimensions, one temporal dimension) as disclosed herein, it is feasible to model the action of a given instrument (say, a scalpel or saw) on bone and tissue. With current technology and its limitations on resolution of successive images and images from differing technologies, this prospect is impossible.

The present invention has been described in connection with the preferred embodiments, however, it is understood that many alternatives are possible without departing from the scope of the invention.

What is claimed:

1. A method of imaging a patient, comprising the steps of:
obtaining a first image of the patient from a first imaging modality along a first predetermined plane at a first predetermined time;
obtaining a second image of the patient from a second imaging modality that is different from the first imaging modality, the second image being obtained along the first predetermined plane at the first predetermined time;
associating the first predetermined time with the first and second obtained images and storing the first and second obtained images together with the first predetermined time in a memory;
shifting either the patient or the first and second imaging modalities such that the first and second imaging modalities are effective to obtain a third and fourth images along a second predetermined plane at a second predetermined time that is later in time than the first predetermined time, and
obtaining a third image of the patient from the first imaging modality along the second predetermined plane at the second predetermined time;
obtaining a fourth image of the patient from the second imaging modality, the fourth image being obtained along the second predetermined plane at the second predetermined time;
associating the second predetermined time with the third and fourth obtained images and storing the third and fourth obtained images together with the second predetermined time in the memory.

2. The method of claim 1, wherein the first and second imaging modalities are selected from a group including magnetic resonance imaging (MRI), computerized axial tomography (CAT), positron emission tomography (PET), and ultrasound scanning (US).

3. The method of claim 1, wherein the first and second images each include respective positional image data points for each of an x-axis, a y-axis and a z-axis relative to an origin point and wherein each of the x, y and z positional image data points of the first and second images is associated with the first predetermined time.

4. The method of claim 1, wherein the second and third images each include respective positional image data points for each of the x-axis, the y-axis and the z-axis relative to the origin point and wherein each of the x, y and z positional image data points of the third and fourth images is associated with the second predetermined time.

5. The method of claim 1, wherein the first to fourth image obtaining steps are carried out with the first and second imaging modalities including respective radio frequency identification devices (RFIDs) configured to store the first to fourth obtained images and wherein the method further includes a step of polling the RFIDs to retrieve therefrom the first to fourth images to store them in the memory.

6. The method of claim 1, further including successively shifting either the patient or the first and second imaging modalities and successively repeating the obtaining, associating and storing steps so as to image at least a selected portion of the patient such that positional image data of each successive image of the patient from both of the first and second imaging modalities is associated with a same predetermine time.

7. The method of claim 1, further including a step of building and displaying a composite image of the patient using at least the obtained first, second third and fourth images.

8. The method of claim 7, further including a step of emphasizing or de-emphasizing contributions from any one of the first and second imaging modalities to the displayed composite image by selectively enhancing or subduing image data from the first, second third or fourth images.

9. The method of claim 1, wherein the obtaining steps are carried out such that the second predetermined plane is adjacent and substantially parallel to the first predetermined plane.

10. A method of imaging a patient, comprising the steps of:
providing an imaging apparatus that includes a plurality of imaging modalities, each of the plurality of imaging modalities being configured to image the patient along a same predetermined plane;
using the provided plurality of imaging modalities, simultaneously obtaining a corresponding plurality of images of the patient along the predetermined plane;
storing, in a memory coupled to the imaging apparatus, the plurality of images of the patient together with an indication of a time at which the plurality of images were simultaneously obtained;
shifting either the patient relative to the imaging apparatus or shifting the imaging apparatus relative to the patient and repeating the simultaneous obtaining and storing steps.

11. The method of claim 10, wherein the plurality of imaging modalities are selected from a group including magnetic resonance imaging (MRI), computerized axial tomography (CAT), positron emission tomography (PET), and ultrasound scanning (US).

12. The method of claim 10, wherein each of the plurality of images includes respective positional image data points for each of an x-axis, a y-axis and a z-axis relative to an origin point and wherein each of the x, y and z positional image data points of the plurality of images taken simultaneously is associated with a same predetermined time.

13. The method of claim 10, wherein the obtaining steps are carried out with the plurality of imaging modalities including respective radio frequency identification devices (RFIDs) configured to store the first to fourth obtained images and wherein the method further includes a step of polling the RFIDs to retrieve therefrom the plurality of images to store them in the memory.

14. The method of claim 10, further including a step of building and displaying a composite image of the patient using at least the obtained plurality of images.

15. The method of claim 14, further including a step of emphasizing or de-emphasizing contributions from any one of the plurality of imaging modalities to the displayed composite image by selectively enhancing or subduing image data from the plurality of images.
